(19) United States
(12) Patent Application Publication
(10) Pub. No.: US 2007/0003917 A1
(43) Pub. Date: Jan. 4, 2007

(54) Medical training system for diagnostic examinations performed by palpation

(75) Inventors: Miles Kitching, Bristol (GB); Nick Gerolemou, Bristol (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: LIMBS AND THINGS LIMITED, BRISTOL BS2 ORA (GB)

(21) Appl. No.: 10/553,465

(22) PCT Filed: Apr. 19, 2004
(86) PCT No.: PCT/GB04/01694

§ 371 Date: Oct. 17, 2005

(30) Foreign Application Priority Data
Apr. 17, 2003 (GB) 0308938.0

(51) Int. Cl. G09B 23/28

(52) U.S. Cl. 434/272; 434/262

(57) ABSTRACT

A sensor for use in a medical training system (2), including a simulation of a body structure (12) which has at least one compartment (13) for containing a mobile substance and a sensor mechanism for detecting pressure applied to the body structure (12).

The present invention relates to a sensor for use in a medical training system.

One of the most fundamental and yet difficult examinations that students learn to perform in the first years of medical school is diagnosis through palpation. The theory of the examination can be learned from textbooks, CD ROM, lectures and observation of experts. While these methods of learning are helpful they do not provide the essential “hands-on” training which is required of a medical practitioner.

There are many soft sections of the body which all have the possibility of harbouring a mass, cyst or a growth, which in the early stages may be identified by means of external palpation. These soft sections can be found on the head, the neck and, in particular, a number of points on the torso, for example, the abdomen, the breasts, the testicles, the groin and the axilla [arm pit]. In addition, trainees are also called upon to identify the position of muscles, nodes, vessels, nerves, and other significant landmarks within the soft tissue structure of the body.

Traditionally students have relied upon examination of real patients who are within the hospital or clinical environment for the learning process. These patients are often uncomfortable and in pain. This can be dangerous and create further pain for the patient and it is also unpredictable, unreliable and variable. In order to objectively examine medical students multiple patients displaying specific conditions are required, and this is almost impossible to achieve.

In order to examine large numbers of medical students during a session or a day, a system called Objective Structured Clinical Examination [OSCE] has been established. Multiple patients are required for days on end within the Clinical Skills environment. If the skills to be examined are invasive, it is not only expensive but restrictive to use actors or volunteers as patients. Over the years actors, models, volunteers or fellow students (called patient simulators) have been employed for such activities. Unless by sheer chance one of these volunteers does indeed have a particular mass or masses within his or her body which can be identified and used for training, he or she is likely to have a normal body and not offer any of the abnormalities which are required for experience for the trainee. The patient simulators are expensive and variable and as such draw continually on resources whilst not providing particularly realistic training.

The demands of training medical professionals are becoming more and more acute. Many countries need more doctors whilst each doctor is being asked to work fewer hours. Fewer patients are spending time in hospital due to the increase of day surgery and minimal invasive surgical techniques. These factors lead to less and less opportunity for the medical trainee to experience any “hands-on” diagnosis at all, let alone in a repetitive way. Unfortunately, litigation is now common due to medical malpractice, and the need to be able to train students comprehensively in clinical diagnosis through palpation is pressing.

In order to assist this difficult situation Clinical Skills Centres have been set up within or by medical training institutions. These centres are growing in number worldwide, providing a safe environment to acquire “hands on” skills until competent. In most cases these centres have computer access and quite comprehensive training takes place.

As well as patient simulators in the form of human beings, a patient simulator in the form of a manikin which is connected to a computer is now well established. This manikin-based patient simulator requires a simulated “theatre environment”. It is designed for procedural training as one finds in anaesthesia and some surgical practice.

Virtual reality is also well developed and it is particularly appropriate for training in endoscopic surgical procedures, and is convincing now that tactile feedback (haptics) has been achieved.

CD ROM based training is also well established and some of the products used are designed around a system of training on models.

Models and simulators are providing “hands-on” training at many levels; skills which are addressed cover simple skills such as knot-tying through to a quite complicated procedure of heart bypass operation.

Models also play an important role in augmented reality; specific instruments and a computer system are linked to scanned data and a model which has been designed and built from that data. Thus the procedure is performed on the model, and images on the screen or display are of the patient scans. These models can provide a very realistic simulation and provide a valuable teaching aid.

The aforementioned systems are all effective systems for training in skills, which, when put together make up a procedure. However, apart from feeling a pulse or listening to breathing sounds and heartbeats, there is no provision for training in diagnostic skills through palpation. Sophisticated manikins provide for training in Accident, Trauma and Emergency when feedback is provided according to the amount of pressure exerted in the case of resuscitation.

It is possible to construct various soft layers with lumps and masses of varying sizes between them and for the trainer and trainee to identify to what condition these lumps and masses relate. However, it is not possible for either the trainer or the trainee to be sure that the trainee has truly felt in the right place and has understood the approach to that part of the human body, or whether undue pressure has been exerted which would have caused pain or damage to the patient.

WO 02/19298 discloses a system for teaching medical examinations performed manually inside a body cavity or anatomical space. The system comprises a tactile sensor placed within an anatomical structure and is particularly intended to be used in pelvic and rectal examinations where the instructor cannot see the hands of the trainee performing the examination. The sensor is connected to a feedback presentation unit which allows the instructor to assess the examination.

United States Patent Application No. 2003/0031993 discloses a system similar to that of WO 02/19298 for the teaching of medical examinations performed by external manual palpation.

U.S. Pat. No. 5,957,694 discloses a canine abdominal palpation simulator for use by veterinary students in developing manual palpation skills. The simulator comprises a canine body with internal artificial organs connected to feedback devices controlled by switches. However, canine anatomy is significantly different from human anatomy and the techniques which students need to learn are different. In addition, the simulator merely provides an indication that a specific organ has been palpated. There is no means for providing feedback as to the quality of the examination or whether the pressure exerted was appropriate.

According to a first aspect of the present invention there is provided a sensor in or for use in a medical training system, the sensor comprising:
a simulation of a body structure, the body structure comprising at least one compartment for containing a mobile substance; and
sensing means for detecting pressure applied to the body structure.

The sensing means may suitably detect displacement of the mobile substance form the or each compartment. Alternatively, the sensing means may detect changes in the internal pressure of the or each compartment.

The mobile substance is a preferably a fluid. The fluid may suitably be a liquid or a gas.

Alternatively, the mobile substance may be a free flowing solid. One such free flowing solid is talc, which is a lubricant which flows in a similar manner to a fluid.

Such a sensor provides a useful tool for use in the training of palpation techniques. The sensor according to the present invention may be used to teach both internal and external manual palpation. The sensor may also be used in the teaching of other medical techniques in which the pressure applied to a particular body structure must be monitored.

One advantage of the present invention is that it is the body structure itself which acts as the sensor. This provides a more accurate representation of the pressure which individual body structures are subjected to during medical procedures. In the prior art medical training systems tactile sensors are placed on or within the body structures. Consequently, the present invention provides a more realistic means of sensing pressure since a force applied to any part of the body structure will be detected by the sensing means.

A further advantage of the present invention is that a single body structure can be used to simulate a variety of medical conditions. The prior art systems are provided with a plurality of replaceable body structures, representing increasing levels of complexity. Using a sensor according to the present invention it is possible to vary the complexity of the situation using a single body structure.

The compartments may suitably be provided such that a number of medical conditions associated with the particular body structure may be accurately simulated. The fluid filled compartment(s) give the body structure a realistic feel. For example, the or each compartment may be filled with a volume of fluid such that the body structure provides a realistic simulation of the body structure in a “normal” anatomical condition. Alternatively, the volume of fluid in the compartment may be increased to simulate a body structure which is subject to swelling or inflammation.

A variety of different situations may be simulated by altering the volume of fluid in the or each compartment. For example, it is possible to bring about a change in surface texture or a hardening or stiffening of the body structure. In addition, it is possible to create bumps, hollows, nodules and hard and soft edges on or within the body structure simply by increasing or decreasing the volume of fluid in the or each compartment. The or each compartment is suitably structured such that a variety of conditions associated with the particular body structure may be simulated. This may be achieved by constructing the walls of the or each compartment with a variety of materials exhibiting differing elastic properties. For example, if it is desired to create a swelling in a particular area of a body structure then the wall of the compartment in this area could be made of a material having greater elastic properties compared to the remainder of the compartment wall. This enables the areas of expansion to be controlled such that the expanded compartments represent actual medical conditions.

The or each compartment may be provided with an inlet valve for introducing fluid into the compartment and an outlet valve connected to the sensing means. However, it is preferred that the or each compartment is in communication with a fluid containing reservoir. The reservoir may suitably be connected to the or each compartment via lengths of tubing. The or each compartment and the reservoir may suitably form a closed system or, alternatively, the reservoir may be provided with an inlet valve for adding additional fluid.

The reservoir may suitably comprise pump means for increasing or decreasing the volume of fluid in the or each fluid containing compartment. The pump means may be provided in the reservoir itself or at any point along the connective tubing between the reservoir and the or each compartment. The pump means may be mechanically or manually operated. A shut-off valve is preferably provided in the reservoir or connective tubing.

The pump means may suitably be connected to control means for controlling the volume of fluid in the or each fluid compartment. The control means may suitably be in the form of a computer system connected to the pump means via a processor. This would enable the user to control the operation of the pump in order to set up the sensor to simulate a number of different medical conditions. The control means is preferably provided with a variety of preset programs corresponding to a particular medical condition. Each preset program controls the fluid volume in the or each compartment to simulate the particular anatomical conditions.

Preferably, the sensing means generates a signal corresponding to the fluid displaced from the or each compartment. The signal preferably corresponds to the volume of fluid displaced from the or each compartment. Additionally, the signal may also correspond to the pressure of the displaced fluid. Thus, not only is it possible to determine whether pressure has been applied to the appropriate area, but also whether the pressure is sufficient for the particular procedure.

It is preferred that the signal is fed to a feedback presentation unit which provides feedback to a user. The feedback presentation unit may take a variety of forms, such as a graphical display.

The simulated body structure preferably corresponds to a simulated human internal body stricture. The simulated internal body structure may comprise a simulated organ. Alternatively, the simulated body structure may comprise a simulated soft tissue structure.

The body structure may suitably comprise a normal anatomy or an anatomy which has an abnormality which may be in the form of a cyst or a growth or an enlargement or a reduction. The enlargement may be a simulation of an internal body structure engorged with fluid.

According to a second aspect of the present invention there is provided a medical training system for diagnostic examinations performed on the human body by palpation comprising:
a simulation of a human anatomical structure, the anatomical structure having an outer surface and an internal cavity;
one or more sensors according to any preceding claim located within the internal cavity; and
a feedback presentation unit in communication with the pressure sensing means for providing feedback to a user.

The simulated anatomical structure preferably comprises one or more of the following human anatomical structures: head, neck, shoulder, arm, leg, axilla, breast, torso, pelvis, knee, foot or any other human anatomical structure.

Preferably, the feedback presentation unit is adjustable to provide feedback for one of a plurality of different medical examinations. The examinations may comprise a set of predetermined steps and the feedback preferably provides an indication of completion of said set of steps.

The feedback presentation unit preferably comprises a display means which may suitably comprise a graphical display. The feedback presentation unit may conveniently be a computer system. The feedback presentation unit preferably comprises a liquid crystal display and/or an analogue display.

According to a third aspect of the present invention there is provided a method of training examinations performed on the human body by palpation comprising the steps of:
receiving signals from the sensing means in a simulation of a human anatomical structure, wherein said signals are generated in response to palpation of the structure; and
providing feedback to a user, wherein said feedback derived, at least in part, from said signals.

The system according to the present invention may suitably be used in conjunction with EP 0 621 974 and EP 0 990 227, both of which are in the name of the present applicant. EP 0 621 974 relates to a simulation of body tissue comprising a member of elastomeric material overlying which is a simulated epidermis in the form of a relatively thin sheet comprising foam latex rubber. The simulated anatomical stricture may suitably be covered with the simulated body tissue.

EP 0 990 227 relates to a skills training system comprising a plurality of simulations of body structures, the simulations being a set of simulations of the same part of the anatomy and being of increasing anatomical complexity and/or presenting increasing clinical or surgical difficulty. Means for receiving at least one of the simulations is provided so that each simulation can be presented in turn for a surgical and/or clinical technique to be practised on the simulation.

For a better understanding of the present invention, reference will now be made to the accompanying drawings, in which:

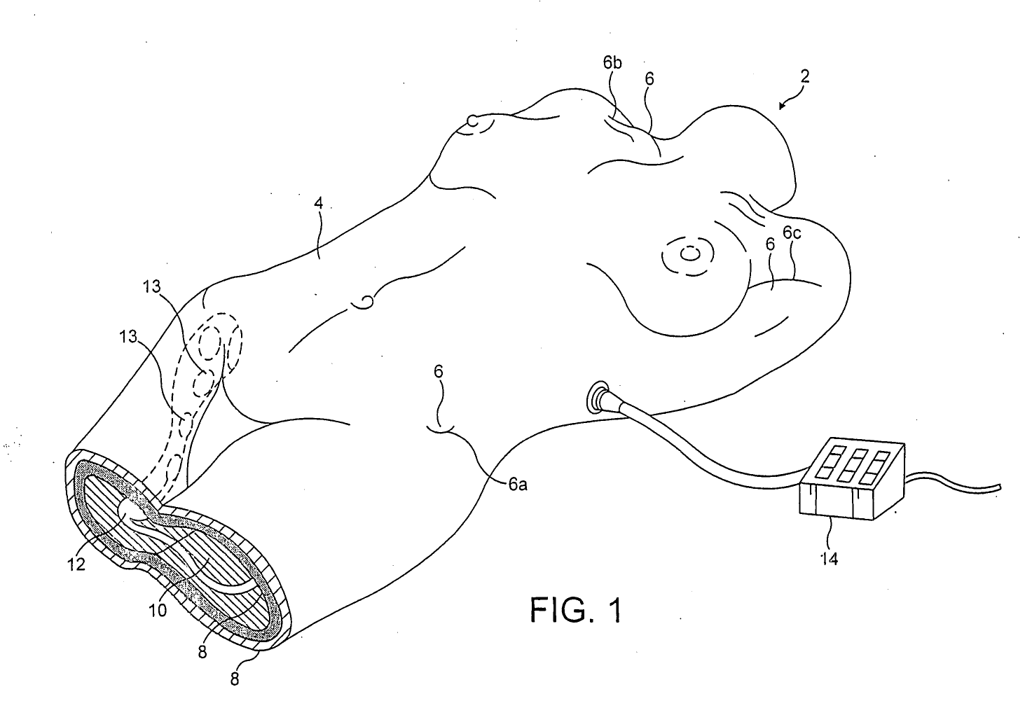

FIG. 1 shows a perspective view of a simulated human torso;

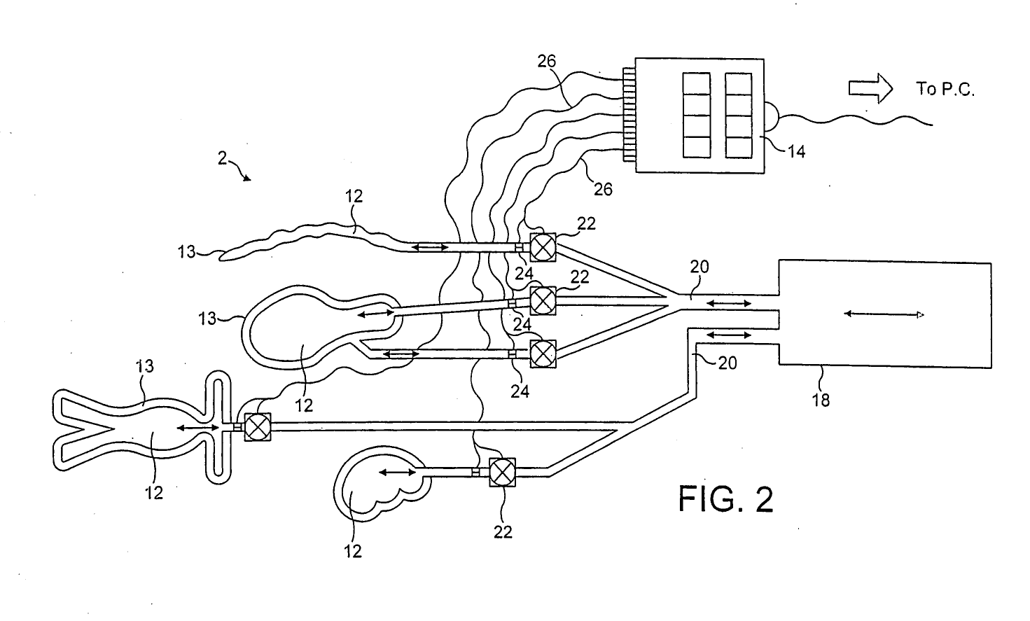

FIG. 2 shows a schematic representation of a medical training system;

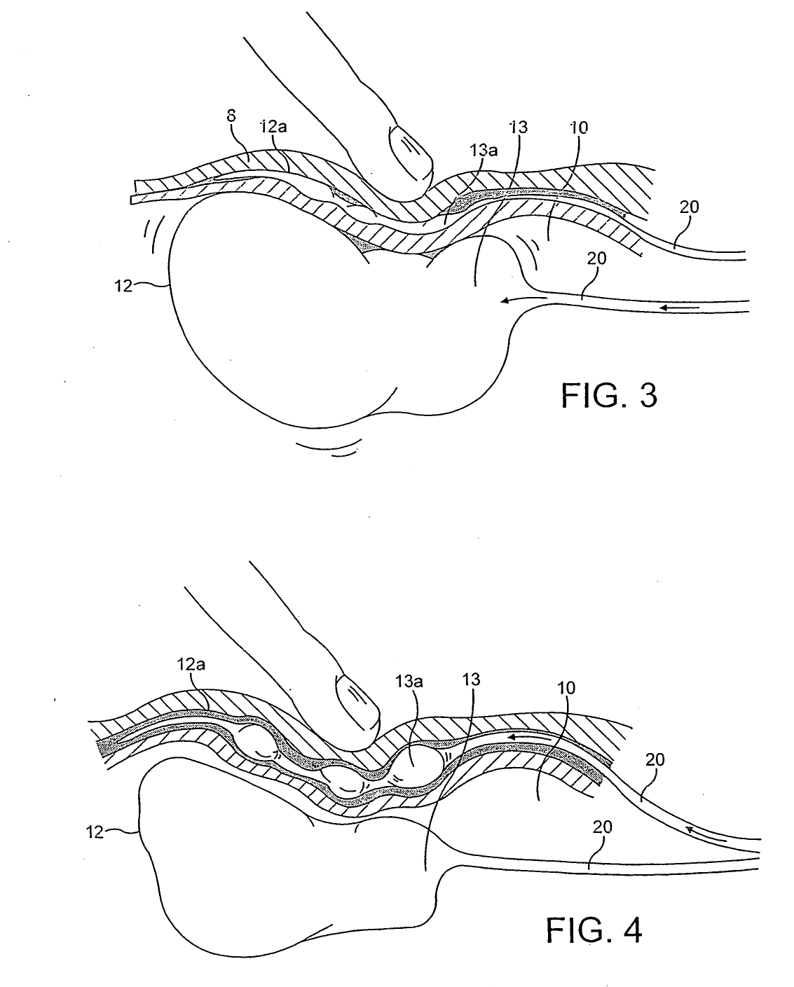

FIG. 3 shows a section view of a sensor within a simulated abdomen;

FIG. 4 shows a section view of the sensor of FIG. 3 representing a different medical condition;

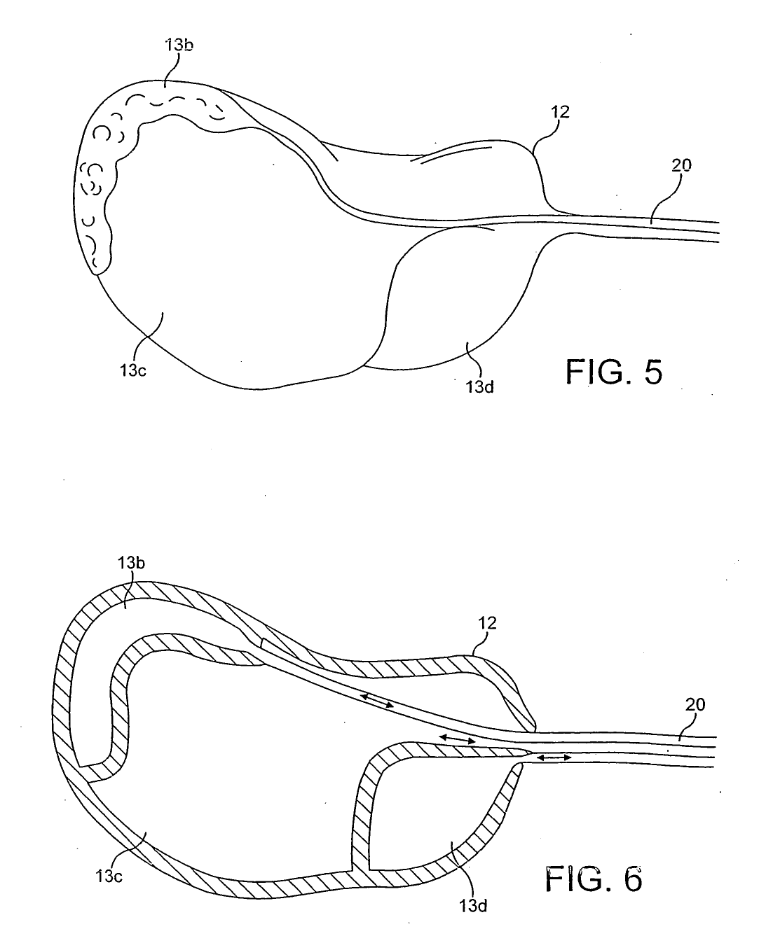

FIG. 5 shows a view of a sensor in a first condition;

FIG. 6 shows a schematic representation of the sensor of FIG. 5.

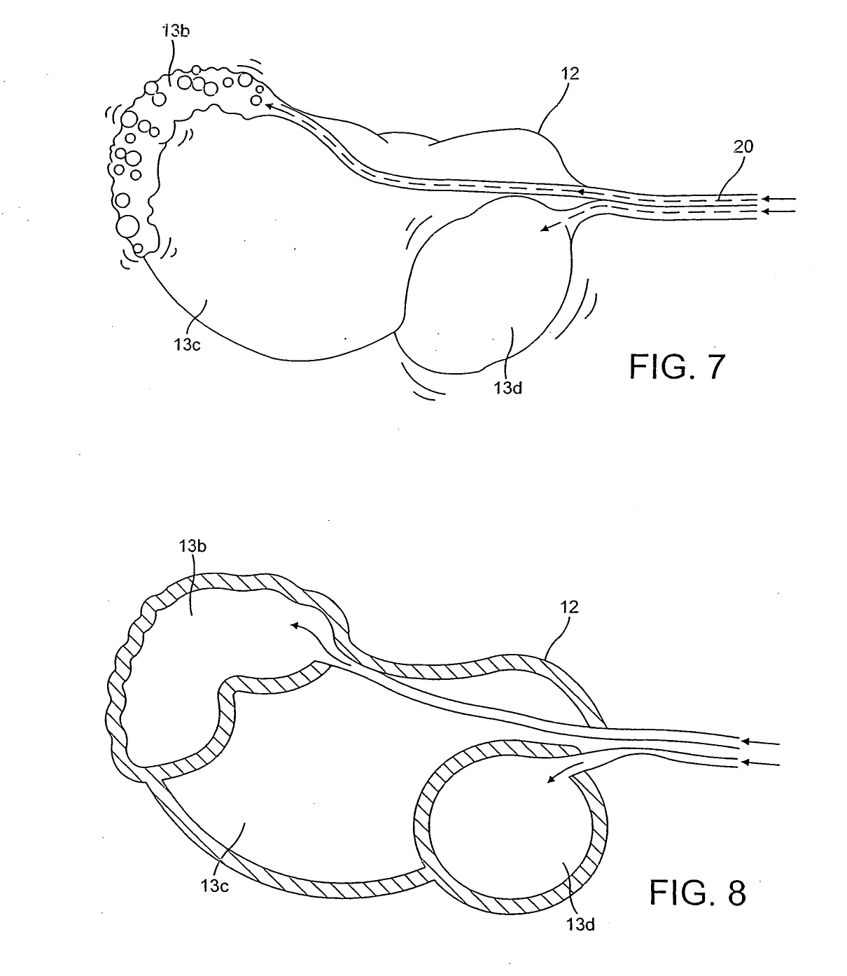

FIG. 7 shows a view of the sensor of FIG. 5 in a second condition

FIG. 8 shows a schematic representation of the sensor of FIG. 7;

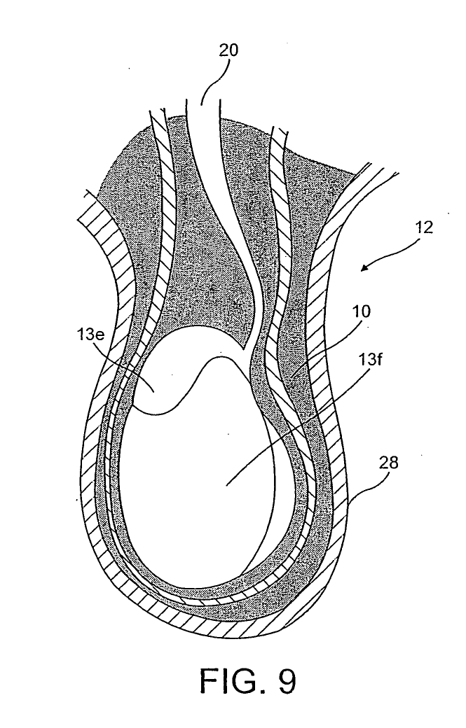

FIG. 9 shows a section view of a simulated testicle in a first condition;

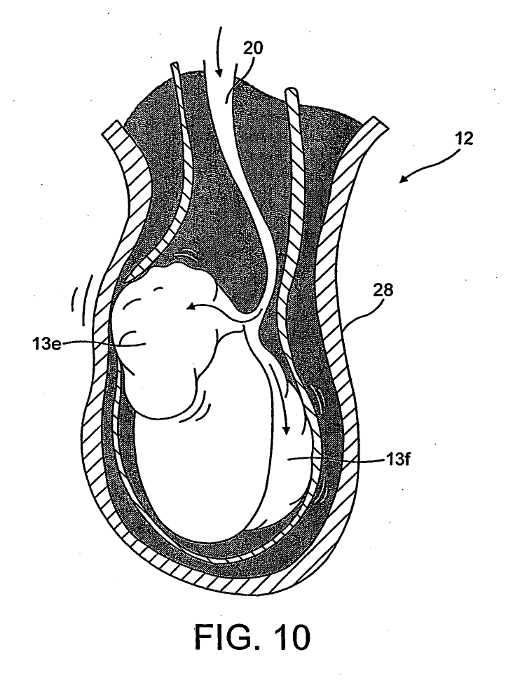

FIG. 10 shows a section view of the simulated testicle of FIG. 9 in a second condition;

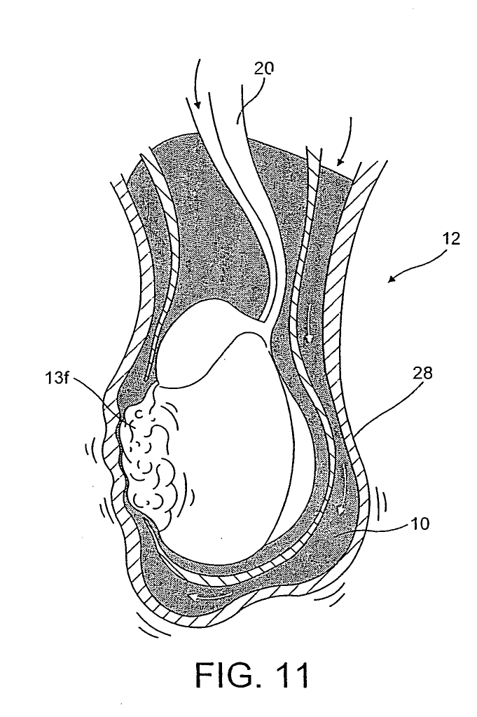

FIG. 11 shows a section view of the simulated testicle of FIG. 9 in a third condition; and

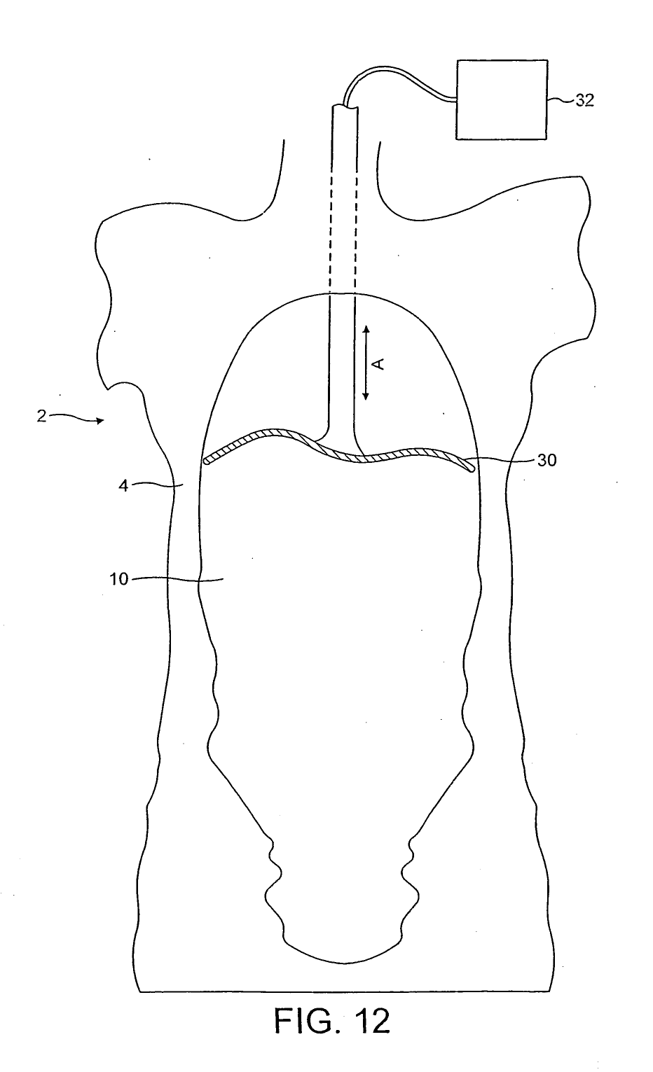

FIG. 12 shows a partially cut-away plan view of another simulated human torso.

Referring firstly to FIG. 1, this shows a medical training system 2 in the form of a simulated human torso 4. The simulated torso 4 is a realistic anatomical representation of a human torso and is provided with a number of anatomical landmarks 6, such as the illiac spine 6a, clavicle 6b and axilla 6c. The accurate positioning of the anatomical landmarks is important in enabling the user to identify the correct region to palpate.

The simulated torso 4 comprises an outer surface 8 in the form of a simulated skin layer and an internal cavity 10.

The internal cavity 10 simulates a human abdominal cavity and is provided with a plurality of mountings (not shown) onto which simulated internal body structures 12 may be fixed. The simulated internal body structures 12 may be in the form of simulated organs or other simulated soft tissue structures such as muscles, nodes, vessels and nerves. Such soft tissue structures should, where appropriate, slide across one another in a realistic way—being made of materials which allow surfaces to move easily across one another. The cavity 10 closely resembles a human abdominal cavity in size and shape and the location of the mountings is such that the position of the internal body structures 12 is anatomically correct. The internal body structures 12 are removable and replaceable.

The internal body structures 12 have at least one compartment (not shown) for containing fluid. This enables the internal body structures 12 to act as sensors for detecting pressure applied by a user during a medical procedure, such as an examination performed by palpation. The internal body structures 12 themselves act as sensors. This is achieved by filling some or all of the internal body structures 12, such as the simulated organs, with a known amount of a liquid or gas. The liquid or gas filled internal body structures 12 are then connected, by means of a length of tubing, to a pressure measurement device. When pressure is applied to the outer surface of the anatomical structure, such as the simulated human torso 4, by means of external manual palpation, some of the liquid or gas will be forced out of the internal body structures 12. This will enable measurements to be taken to determine the force applied and whether it was appropriate to the particular examination being performed. The results may be displayed in any suitable manner by feedback presentation unit 14. The operation of the body structures 12 as sensors will be described in more detail below.

In FIG. 1 the training system 2 is in the form of a human torso 4. However, this is merely one embodiment of the invention and the system 2 may in fact be in the form of any human anatomical structure which may be subjected to palpation or any other medical procedure in which pressure applied to body structures must be monitored. The system 2 may be in the form of one or more of the following human anatomical structures: head, neck, shoulder, axilla, breast, torso, pelvis, knee, foot or other area of the human body. Each individual system 2 may be a stand alone module upon which specific examinations may be practised or it may be a modular unit which may be combined together with other units to form a single larger model. In an alternative embodiment the individual modules may be in the form of strap-on modules which may be worn by a human or manikin in order to increase realism, for example a strap-on breast. Similarly, the simulated internal body structures 12 may be in the form of any internal body structure which may be examined by palpation.

The system 2 also comprises a feedback presentation unit 14 in communication with the or each sensor. The feedback presentation unit 14 has a display screen (not shown) and provides information regarding the quality of the examination. The feedback presentation unit 14 can provide visual information on whether the user has palpated in the correct place and whether the correct pressure has been exerted. Alternatively, the feedback display unit 14 may provide other types of feedback, for example, auditory, tactile or some other indication.

The feedback presentation unit 14 has a processor which processes the information from the sensors and provides an indication of the quality of the exam. The processor may suitably be configured to provide feedback on a specific examination type. For example, in the simulated human torso 4 of FIG. 1 there are a number of simulated internal body structures 12 within the cavity 10 which may be examined individually. However, examination of one internal body structure 12 may result in an incidental force being exerted on another internal body structure 12. The system 2 may be set up for a number of different exams and the processor will interpret the signals form the sensors depending on the exam type. The signal generated by the sensors is in direct relationship to the size of the external force exerted. Consequently, the processor can determine whether the appropriate pressure has been applied.

The processor may also include comparative data corresponding to a correctly performed examination. This enables the performance of a user to be compared to a consistent reference point and enables feedback to be provided whilst the examination is being performed.

FIG. 2 shows a schematic representation of a medical training system 2. The system 2 comprises a plurality of simulated body structures 12, each body structure 12 having at least one compartment 13 for containing a volume of fluid. Each compartment 13 is in communication with a fluid reservoir 18 via a series of tubes 20. Fluid is able to flow into and out of the compartments 13 as indicated by the arrows. Pumps 22 are provided between the reservoir 18 and the compartments 13. The pumps 22 may be mechanically or manually operated and provide a means for altering the volume of fluid within the compartments 13. Each pump 22 is provided with a shut-off valve.

Sensing means 24 are provided for measuring the displacement of fluid from each compartment 13 in use of the system 2. The sensing means 24 may be electronic or mechanical and provide a signal in response to the volume and/or pressure of the fluid displaced by palpation of the body structure 12. The signal generated by the sensing means 24 is fed to the feedback presentation unit 14 via cables 26. Alternatively, blue tooth or any other transmitting system may be used to send the signal to the feedback unit. The feedback presentation unit 14 is connected to a computer system such that the system 2 may be controlled and monitored using suitable software installed on the computer system. The computer system may be provided with a variety of predetermined programs corresponding to fluid pressures required in the individual compartments 13 for the simulation of particular conditions.

FIG. 3 shows a section view of a sensor, in the form of a body structure 12, within a simulated abdomen. The body structure 12 is a simulation of a soft tissue structure such as a liver or spleen. The whole body structure 12 is in the form of a fluid containing compartment 13 and is connected via a length of tubing to a fluid reservoir (not shown). Arrows are shown indicating the flow of fluid into the compartment 13. When the required volume of fluid has been supplied to the compartment 13 the pump (not shown) is shut off and the volume of fluid in the compartment 13 remains constant. A further body structure 12a is also shown. This body structure 12a represents a “normal” state and the compartment 13a only contains a minimal volume of fluid.

When a force is applied manually to the outer surface 8 of the simulated abdomen fluid contained within the compartment 13 is forced out of the compartment 13, in the reverse direction of the arrow, and is detected by the sensing means (shown in FIG. 2). The sensing means detects the volume and the pressure of the displaced fluid and generates a signal which is passed to the feedback presentation unit 14. As there is only a minimal volume of fluid in compartment 13a only a small amount of fluid, if any, will be displaced from this compartment.

In an alternative embodiment the sensing means may be configured to measure the change in pressure within the or each compartment in response to the applied pressure.

FIG. 4 shows a section view of the sensor of FIG. 3 representing a different medical condition to that shown in FIG. 3. The body structure 12a is shown with an increased volume of fluid in compartment 13a. The walls of compartment 13a are made of material exhibiting different levels of elasticity in different regions. Consequently, those areas having a higher elasticity expand more and a number of nodules are formed under the skin layer. These nodules can be detected by external manual palpation of the body structure 12a.

FIGS. 5 and 6 show views of a further embodiment of a sensor according to the present invention. The sensor is in the form of a body structure 12. The body structure 12 has three distinct compartments 13b, 13c and 13d each of which may be independently filled with fluid. This enables a variety of medical conditions to be simulated using a single body structure 12. In addition, as can be seen in FIG. 5, the outer surface of the body structure 12 in the region of compartment 13b is textured to create a detectable texture when the body structure 12 is palpated. The texture of the body structure 12 will change when the volume of fluid in compartment 13b is increased, just as would happen in a human anatomy.

FIGS. 7 and 8 show views of the sensor of FIGS. 5 and 6 in a second condition. The second condition represents a situation of increased medical complexity. As can be seen in FIGS. 7 and 8 the volume of fluid in compartments 13b and 13d has been increased and the compartments 13b, 13d have expanded. This represents a swelling or inflammation of the body structure 12. In particular, the nodules on the outer surface of compartment 13b have expanded and should now be detectable by external manual palpation.

The additional fluid in compartments 13b, 13d is pumped by the pumps from the fluid reservoir via the connective tubing (as shown in FIG. 2). Control means, such as a computer system, enable precise amounts of fluid to be pumped into the compartments 13b, 13c and 13d in order to simulate particular medical conditions. The control means is provided with a number of predetermined programs corresponding to particular medical conditions. A user may begin with a basic program simulating a “normal” condition and then may progress to situations of increasing medical complexity by increasing or decreasing the volume of fluid in the compartments 13b, 13c, 13d.

Pressure exerted on the body stricture 12 by manual palpation or other means causes fluid to be displaced from the compartments 13b, 13c, 13d. The displaced fluid is forced back along the connective tubing and is detected by sensing means which determines the volume and/or pressure of the fluid. A signal is generated by the sensing means and is delivered to the feedback presentation unit 14. A number of feedback means are possible, such as visual and/or audible signals.

FIGS. 9-11 show a simulated body structure 12 in the from of a simulated testicle exhibiting various medical conditions. FIG. 9 shows the simulated testicle in a “normal” condition. The body structure 12 is provided within a simulated scrotum 28. The connective tubing 20 represents the vas of the testicle and is connected to the fluid reservoir (not shown). The vas is connected to the epididymis and testes which are in the form of compartments 13e, 13f. The compartments contain a volume of fluid which creates an accurate simulation of a testicle in a “normal” condition.

In FIG. 10 the testicle is shown in a condition known as epididymitis. Additional fluid has been pumped into the epididymis 13e via the vas 20 such that the outer wall of the epididymis expands into a swollen state indicative of epididymitis.

FIG. 11 shows a further view of the simulated testicle of FIG. 9. In this case additional fluid has been pumped into the testes 13f. The outer wall of the testes is shown in an expanded state and a plurality of nodules are visible on the outer surface of the testes 13f. This simulation represents a cancerous lump. In addition, extra fluid has also been pumped into the scrotum 28.

FIG. 12 shows a partially cut away view of an alternative embodiment of a medical training system 2, also in the form of a torso 4. The torso 4 comprises a mechanical diaphragm which can operate to simulate a breathing movement within the torso 4. The simulated breathing action caused by the operation of the diaphragm causes pressure changes within the compartments 13 which are comparable to the pressure changes experienced by human internal body structures caused by breathing. The mechanical diaphragm comprises a pressure plate 30 which is linearly actuable as indicated by arrow A. Movement of the pressure plate 30 as indicated causes compression of the air within the internal cavity 10 of the torso 4 and provides a simulation of a breathing movement. The pressure plate 30 is connected to actuating means 32 which may be a mechanical or foot activated bellows, pump, piston or any other suitable actuating means.

In addition to providing improved visual realism the mechanical diaphragm simulates the effect which breathing, coughing or other movements have on the internal state of the organs, thus providing improved anatomical realism and further options for simulation of medical conditions. The medical training system 2 shown in FIG. 12 may be used with the sensors as described in relation to FIGS. 2-11.

We claim:

1-37. (canceled)

38. A sensor for use in a medical training system, the sensor comprising:
a simulation of a body structure, the body structure comprising at least one compartment for containing a mobile substance; and
sensing means for detecting pressure applied to the body structure.

39. A sensor according to claim 38, wherein the sensing means senses displacement of the mobile substance from each of the at least one compartment or detects changes in the internal pressure of each of the at least one compartment.

40. A sensor according to claim 38 wherein the mobile substance is a fluid or a free flowing solid.

41. A sensor according to claim 40, wherein the mobile substance is a free flowing fluid and each of the at least one compartment is in communication with a fluid containing reservoir.

42. A sensor according to claim 41, wherein the reservior comprises pump means for increasing or decreasing the volume of fluid in each of the least one fluid compartment.

43. A sensor according to claim 42, wherein the pump means is connected to control means for controlling the volume of fluid in each of the at least one fluid compartment.

44. A sensor according to claim 43, wherein the control means is provided with a variety of predetermined fluid volumes corresponding to a variety of different anatomical conditions.

45. A sensor according to claim 40, wherein the mobile substance is a fluid and the sensing means detects displacement of the fluid from each of the at least one compartment and generates a signal corresponding to the fluid displaced from the or each compartment.

46. A sensor according to claim 45, wherein the signal corresponds to the volume of fluid displaced from each of the at least one compartment or pressure of the displaced fluid.

47. A sensor according to claim 45, wherein the sensing means detects changes in the pressure of each of the at least one compartment and generates a signal corresponding to the pressure change.

48. A sensor according to claim 45, wherein the sensing means detects changes in the internal pressure of each of the at least one compartment and generates a signal corresponding to the pressure change.

49. A sensor according any preceding claim, wherein the simulated body structure corresponds to a simulated human internal body structure.

50. A sensor according to claim 49, wherein the signal is fed to a feedback presentation unit which provides feedback to a user.

51. A medical training system for diagnostic examinations performed on the human body by palpation comprising:
a simulation of a human anatomical structure, the anatomical structure having an outer surface and an internal cavity;
one or more sensors according to claim 38 located within the internal cavity; and
a feedback presentation unit in communication with the pressure sensing means for providing feedback to a user.

52. A system according to claim 51, wherein the anatomical structure is selected from the group comprising a human torso, a female breast, a human head, a human heck, a human shoulder, a human leg, a human arm, a human axilla, a human pelvis, a human knee and a human foot.

53. A system according to claim 51, wherein said simulation and said feedback presentation unit are adjustable to provide feedback for one of a plurality of different medical examinations.

54. A system according to claim 51, wherein said medical examination comprises a set of predetermined steps and said feedback comprises an indication of completion of said set of predetermined steps.

55. A system according to claim 51, wherein the feedback presentation unit is selected from the group comprising display means, a graphical display, a liquid crystal display and an analogue display unit.

56. A method of training examinations performed on the human body by palpation using a system according to claim 51 comprising the steps of:
receiving signals from the sensor, wherein said signals are generated in response to palpation of the sensor; and
providing feedback to a user, wherein said feedback is derived, at least in part, from said signals.

57. A method of training examination according to claim 56, wherein the volume of fluid in the or each fluid containing compartment is altered to present the user with a variety of simulations representing increasing anatomical complexity or increasing clinical difficulty.
